(19) United States
(12) Patent Application Publication
(10) Pub. No.: US 2012/0086340 A1
(43) Pub. Date: Apr. 12, 2012

(54) AIR-COOLING ILLUMINATION APPARATUS

(76) Inventor: Kenjiro Hashizume, Osaka (JP)

(21) Appl. No.: 12/901,277

(22) Filed: Oct. 8, 2010

(51) Int. Cl. H01J 61/52; F21V 29/00

(52) U.S. Cl. 315/112; 362/373

(57) ABSTRACT

An air-cooling illumination apparatus capable of reducing deteriorations caused by the heat generated by the illumination apparatus includes a fan, a lamp installed on an air passage movable by a rotation of the fan, a connecting portion connected to the lamp and the fan, and a plate portion formed at an air suction end of the fan and arranged with a first interval apart from the fan. The fan includes a rotatable vane portion, and a frame mounted around the periphery of the vane portion. The lamp is installed at the periphery of the frame and includes an air blowing end for blowing air from the fan and a projecting portion for projecting light. A second interval is formed between the lamp and the plate portion.

### BACKGROUND OF THE INVENTION

a) Field of the Invention

The present invention relates to an air-cooling illumination apparatus.

b) Description of the Related Art

In recent years, illumination apparatuses including LED (Light emitting Diode) lamps become increasingly popular, such as a desk lamp with a shade turnable at an end of a halogen bulb during its use (as disclosed in Japanese Laid-Open Patent Application No. 2005-183351), and the desk lamp includes a fluorescent lamp, an LED lamp used as a safety lamp, and a halogen lamp installed in the shade.

However, the fluorescent lamp, LED lamp and halogen lamp of the illumination apparatus as disclosed in the aforementioned patent generates heat that will deteriorate the illumination apparatus easily.

### SUMMARY OF THE INVENTION

Therefore, it is a first objective of the invention to overcome the drawback of the conventional illumination apparatus by providing an air-cooling illumination apparatus capable of reducing the heat generated by the illumination apparatus. To achieve the first objective, the present invention provides an air-cooling illumination apparatus comprising a fan, a lamp installed along an air passage that moves with the rotation of the fan, and a connecting portion coupled to the lamp and the fan.

A second objective of the present invention is to provide an air-cooling illumination apparatus further comprising a plate portion disposed at an air suction end of the fan and with a first interval apart from the fan, and the fan includes a rotatable vane portion and a frame mounted around the vane portion, and the lamp includes a projecting portion disposed around the periphery of the frame for projecting light to an air blowing end of the fan, wherein the lamp and the plate portion are arranged with a second interval apart.

A third objective of the present invention is to provide an air-cooling illumination apparatus comprising a connecting portion having a fan mount portion for installing the fan and a lamp support portion disposed around the fan mount portion for supporting the lamp, and the plate portion is fixed onto the connecting portion.

A fourth objective of the present invention is to provide an air-cooling illumination apparatus with a difference from the third preferred embodiment that the lamp is in the shape of a thick plate supported by the lamp support portion of the lamp that can rotate about an axis along the long-side direction.

A fifth objective of the present invention is to provide an air-cooling illumination apparatus with a difference from the fourth preferred embodiment that the fan mount portion is in a rectangular (or square) shape, and the lamp support portion is disposed at four corners of the rectangular shape, and four sides of the rectangular shape are disposed parallel to four sides of the rectangular shape and with an interval apart from the long side of each lamp respectively.

A sixth objective of the present invention is to provide an air-cooling illumination apparatus with a difference from the second preferred embodiment that the lamp is installed at an opposite end of the projecting portion and includes a cooling fin portion for cooling the projecting portion, and the second interval is formed between a cooling fin portion and the plate portion, and the fan sucks air through the second interval and the first interval.

A seventh objective of the present invention is to provide an air-cooling illumination apparatus with a difference from the second preferred embodiment that the air-cooling illumination apparatus further comprises a temperature sensor for detecting the temperature of the projecting portion, and a control portion for controlling the fan according to the temperature detected by the temperature sensor.

An eighth objective of the present invention is to provide an air-cooling illumination apparatus with a difference from the seventh preferred embodiment that the connecting portion connected to a fluorescent lamp or LED lamp includes a power hub having a plurality of power supply devices for supplying electric power.

The present invention can provide an air-cooling illumination apparatus capable of reducing the heat generated by the illumination apparatus and preventing the illumination apparatus from being deteriorated by the heat.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 is a perspective front view of an air-cooling illumination apparatus in accordance with a first preferred embodiment of the present invention.

FIG. 2 is a perspective side view of an air-cooling illumination apparatus in accordance with a first preferred embodiment of the present invention.

FIG. 3 is a perspective exploded view of an air-cooling illumination apparatus in accordance with a first preferred embodiment of the present invention.

FIG. 4 is a perspective front view of an air-cooling illumination apparatus in accordance with a first preferred embodiment of the present invention.

FIG. 5 is a perspective rear view of an air-cooling illumination apparatus with a lamp in accordance with a first preferred embodiment of the present invention.

FIG. 6 is a front view of a connector of an air-cooling illumination apparatus in accordance with a first preferred embodiment of the present invention.

FIG. 7 is a cross-sectional view of an air-cooling illumination apparatus in accordance with a first preferred embodiment of the present invention.

FIG. 8 is a perspective front view of an air-cooling illumination apparatus in accordance with a second preferred embodiment of the present invention.

FIG. 9 is a perspective side view of an air-cooling illumination apparatus in accordance with a second preferred embodiment of the present invention.

FIG. 10 is a cross-sectional view of an air-cooling illumination apparatus in accordance with a second preferred embodiment of the present invention.

FIG. 11 is a schematic view of supplying power to an air-cooling illumination apparatus in accordance with a first preferred embodiment of the present invention.

### DETAILED DESCRIPTION OF THE PREFERRED EMBODIMENTS

The technical characteristics and advantages of the present invention will become apparent with the detailed description of the preferred embodiments and the illustration of related drawings as follows.

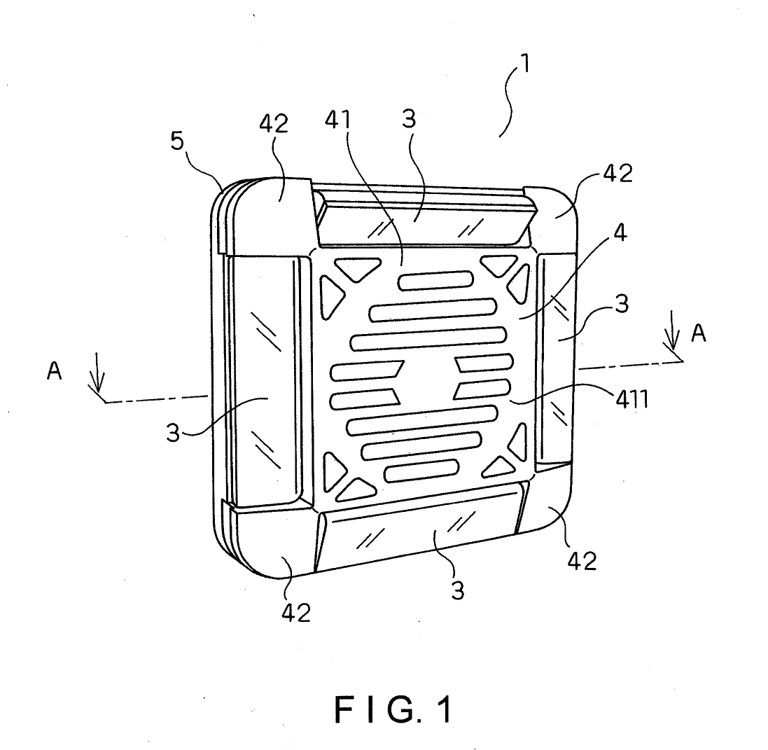

With reference to FIGS. 1 to 3 for a perspective front view, a perspective side view, and an exploded view of an air-cooling illumination apparatus in accordance with a first preferred embodiment of the present invention respectively, the air-cooling illumination apparatus 1 comprises a lamp 3 in a thick-plate shape and arranged around the fan 2 with respect to the center of the fan 2, a connecting portion 4 formed and covered at a front end of the fan 2 for connecting the fan 2 and the lamp 3, and a plate portion 5 formed at a rear end of the fan 2 for clamping the fan 2.

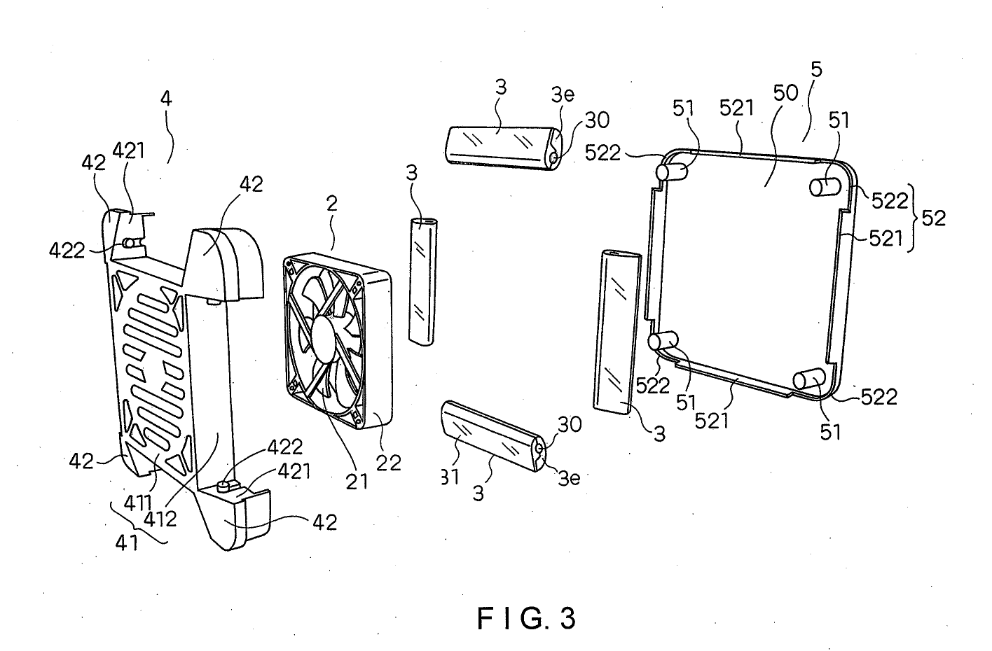

In FIG. 3, the fan 2 comprises a vane portion 21 having a plurality of vanes installed around the rotating axis of the fan 2, and a frame 22 mounted around the vane portion 21. The front side of the frame 22 is in a rectangular (or square) shape, and a lamp 3 is installed at a position parallel to each respective side of the rectangular shape. The fan 2 sucks air in an axial direction and blows air in a direction as indicated by arrows of the figures. In other words, the air is sucked from an inner side of the fan and blows air out from a front end of the fan.

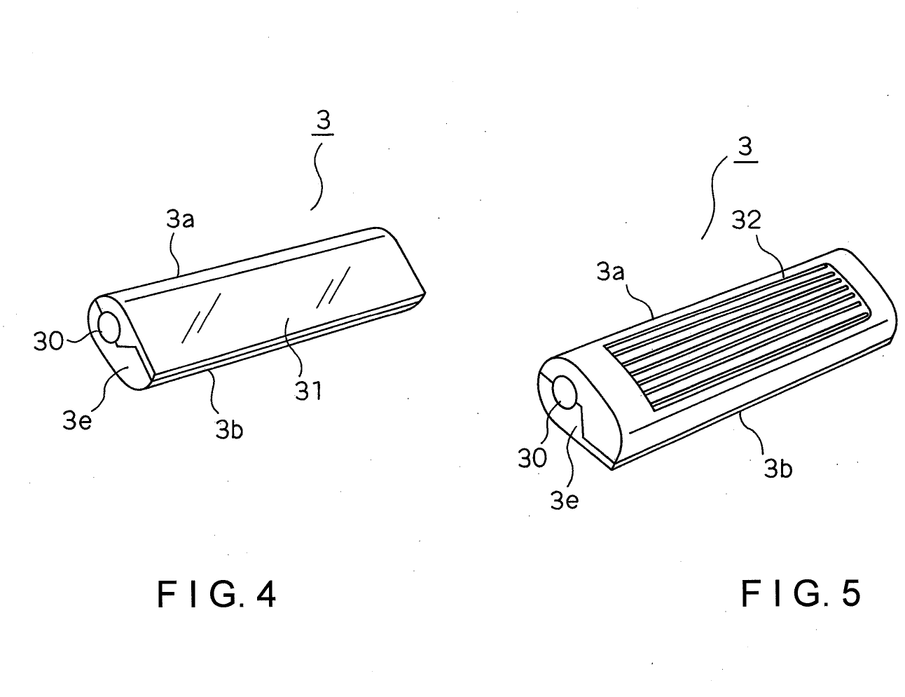

With reference to FIGS. 4 and 5 for a perspective front view and a perspective rear view of an air-cooling illumination apparatus in accordance with a first preferred embodiment of the present invention respectively, the lamp 3 is in a thick-plate shape, and the thickness of the lamp 3 is tapered from an end 3a to the other end 3b. The end 3a is disposed at an end of the frame 22 (as shown in FIG.3). On distal surfaces 3e along a long side, a recession 30 is formed and extended from the end 3a and provided for inserting a support portion to support the lamp 3. In FIG. 4, the lamp 3 has an illumination portion 31 disposed on a surface of the lamp 3. The illumination portion 31 is a structure having a plurality of light emitting diodes (LEDs). In FIG. 5, the lamp 3 includes a cooling fin portion 32 disposed on an internal side of the lamp 3. The cooling fin portion 32 includes a plurality of fins installed thereon and provided for cooling the illumination portion 31. In addition to the LED lamp, the illumination device installed on the illumination portion 31 can also be a fluorescent lamp or a halogen lamp.

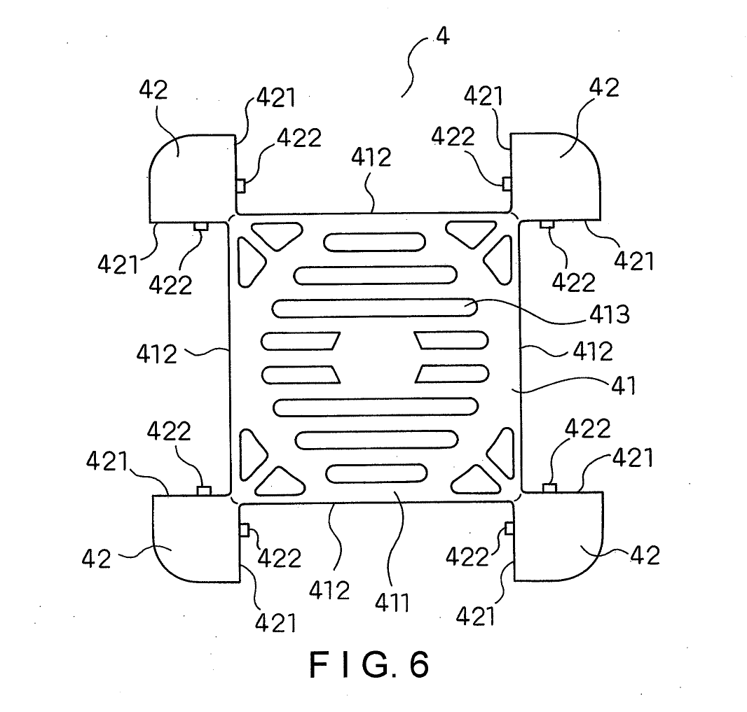

With reference to FIG. 6 for a front view of a connecting portion 4 of an air-cooling illumination apparatus in accordance with a first preferred embodiment of the present invention, the connecting portion 4 as shown in FIGS. 3 and 6 comprises a fan mount portion 41 for mounting the fan 2 by insertion, and the fan mount portion 41 is in a rectangular (or square) shape, and a lamp support portion 42, disposed separately at four corners of the rectangular shape. Except for the internal side of the fan mount portion 41, the front side 411 and lateral sides 412 of the fan mount portion 41 of the fan mount portion 41 covering the fan 2 are in the shape of a box, and the fan mount portion 41 includes a plurality of air openings 413 formed at the front side 411 of the fan mount portion 41. Air is blown from the fan 2 to the front through the air openings 413. A screw or an adhesive can be used for fixing the fan 2 onto the fan mount portion 41.

In the whole assembly of the air-cooling illumination apparatus 1 (as shown in FIG. 1), the lamp support portion 42 of the connecting portion 4 is in the shape of a sector. Each lamp support portion 42 has two lateral sides 421 perpendicular to the lateral sides 412 of the fan mount portion 41 respectively (as shown in FIG. 3). In FIG. 6, a protrusion 422 is perpendicularly protruded from each of the lateral sides 421.

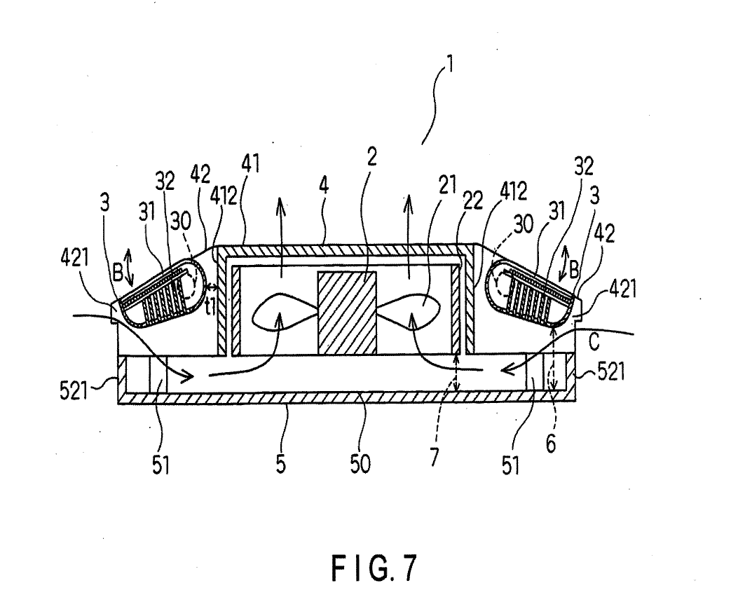

In FIG. 3, a recession 30 is formed separately on distal surfaces 3e of the lamp 3 and provided for receiving the protrusion 422 formed on the lateral side 421 opposite to the adjacent lamp support portion 42, such that the lamp 3 can be supported by the connecting portion 4 and rotated freely about an axis (which is a line connecting both ends of the recession 30). A conventional structure for maintaining the rotation can be adopted. For example, elastic plates with a V-shaped cross-section can be installed on both distal surfaces 3e , and the recessions are formed on the lateral side 421 and with respect to the center of the protrusion, and the V-shaped elastic plates can be embedded into the recessions appropriately to keep the lamp 3 at several rotating positions. Alternately, no recession is formed, but the V-shaped elastic plates abut against the lateral sides 421 respectively to hold the lamp 3. With a rotation of the lamp 3, the projecting position of the lamp 3 can be changed to provide light at an appropriate position to users. To achieve the effect of rotating the lamp 3, an interval t1 (as shown in FIG. 7) is formed between the lamp 3 and the lateral side 421, so that the rotation of the lamp 3 will not interfere with the lateral sides 421.

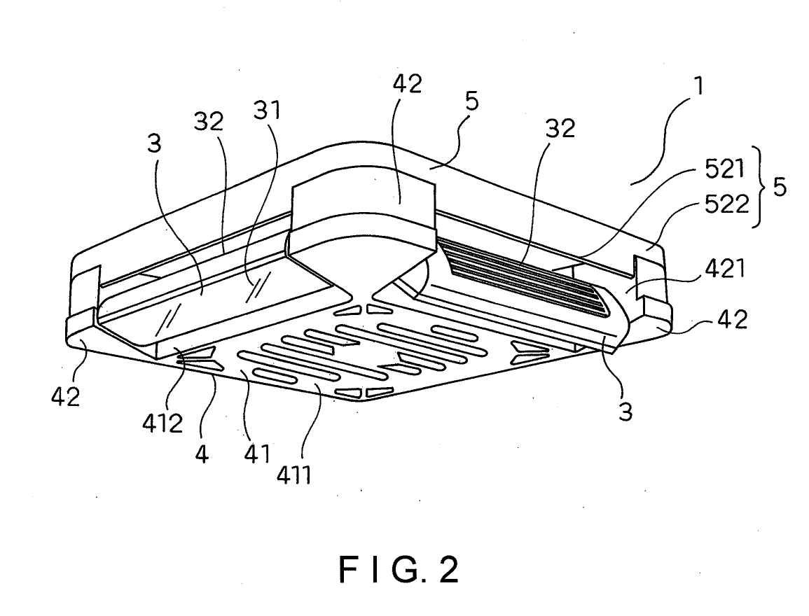

In FIG. 3, the plate portion 5 further includes a planar portion 50 in a square shape with four round corners, and a protrusion 51 is formed perpendicularly at a position of a plane proximate to the four corners. The protrusion 51 is provided for fixing the plate portion 5 and the connecting portion 4, and embedded into the recession (not shown in the figure) of the connecting portion 4. The structure for fixing the plate portion 5 and the connecting portion 4 is not limited to the aforementioned structure, but a screw, an adhesive or any equivalent fixing agent can be used for the same purpose. A flange 52 is perpendicularly formed on a plane at an edge of the plate portion 5, and the flange 52 has a height greater than the four corner portions 522 at the edge 521 of the rectangular shape. In FIG. 2, the edge 521 can be embedded and fitted in the length of the lamp support portion 42.

With reference to FIG, 7 for a cross-sectional view of Section AA′ of FIG. 1, the external side faces upward and the internal side faces downward in the figure. In FIG. 7, an interval 6 is formed between the plate portion 5 and the lamp 3, and an interval 7 is formed between the fan 2 and the plate portion 5. The interval 7 is equivalent to the interval adopted in an example for achieving the first objective of the present invention, and the interval 6 is equivalent to the interval adopted in an example for achieving the second objective of the present invention.

A switch (not shown in the figure) is switched on to start rotating the fan 2, while the LED of the illumination portion 31 is emitting light. Air will be passed through the interval 6 and the interval 7 sequentially and sucked from an internal side of the fan 2 and blown towards the front through the air openings 413 (as shown FIG.6). With reference to FIG. 7 for the details, the air is passed sequentially through the spaces between the cooling fin portion 32 of the lamp 3 and the edge 521 of the flange 52, between the cooling fin portion 32 and the planar portion 50, between a distal end of the internal lateral side 412 (air sucking end) and the planar portion 50 of the plate portion 5, between a distal and of the internal side of the frame 22 (air sucking end) and the planar portion 50 of the plate portion 5, and sucked by the fan 2 (as indicated by the arrow C in the figure).

Since the cooling fin portion 32 is disposed on an air passage where the fan 2 sucks air and provided for cooling the illumination portion 31, therefore the heat generated by the illumination portion 31 can be cooled efficiently to prevent the lamp installed to the illumination portion 31 from being deteriorated.

When the air-cooling illumination apparatus in accordance with this preferred embodiment of the present invention is applied to a desk in an office, the support portion designed at the internal side of the plate portion 5 can be used for preventing the illumination apparatus from being toppled, or the support portion can be the support platform of the fan. In addition, a penetrating hole can be formed on an internal side of the plate portion 5 and provided for hanging the illumination apparatus on a wall.

In an air-cooling illumination apparatus in accordance with a second preferred embodiment of the present invention second, the second preferred embodiment is substantially the same as the first preferred embodiment, except that the air openings of this embodiment is different, and their similarity and difference will be described as follows. It is noteworthy to point out that same numerals are used for representing respective elements in the following description.

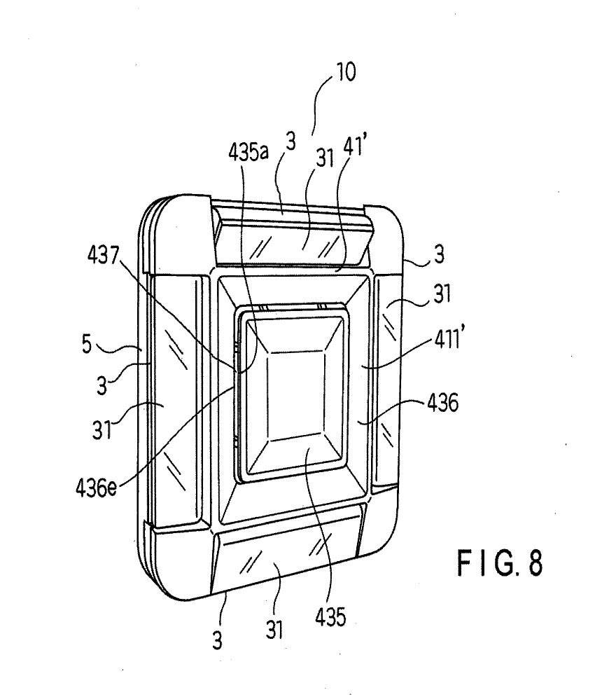

With reference to FIG. 8 for a perspective front view of an air-cooling illumination apparatus 10 in accordance with a second preferred embodiment of the present invention, the shape of the front side of the fan mount portion of the air-cooling illumination apparatus 10 of the second preferred embodiment is different from that of the first preferred embodiment, and the front side 411′ of the fan mount portion 41′ of the second preferred embodiment has a center 435 of a rectangular plate and an edge portion 436 formed at the periphery of the center 435. The central portion of the center 435 is more concave than the periphery. A concave mortor is formed at the periphery 436 and extended from the edge of the front side 411′ to the center, and the center 435 is protruded from a central end 436e of the edge portion 436. With the protruding center 435, an interval can be formed between the central end 436e of the edge portion 436 and the edge 435a of the center 435. The interval is used as the air openings 437 for the fan 2 to blow air towards the front. The air passed through the air openings 437 and dispersed to the surrounding through the edge portion 436 of the mortor.

In the second preferred embodiment as described above, the air blown from the fan can be dispersed to achieve a comfortable effect without blowing wind directly at users.

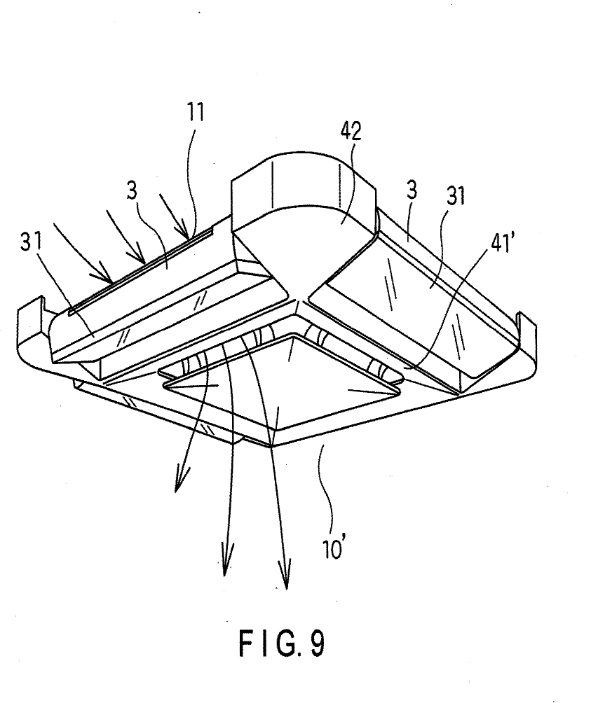

In addition, the air-cooling illumination apparatus 10 can be installed onto a desk or a ceiling. If the air-cooling illumination apparatus 10 is installed onto a ceiling, the internal side of the plate portion 5 of the air-cooling illumination apparatus 10′ can be installed in contact with the ceiling as shown in FIG. 9, but the plate portion 5 is not installed directly onto the ceiling. Now, the lamp support portion 42 is in contact with the ceiling, and an interval 11 is formed between the lamp 3 and the ceiling. The interval 11 is equivalent to the interval adopted in an example for achieving the second objective of the present invention second, and the ceiling is an example of the plate portion of the present invention. In addition, the air-cooling illumination apparatus 10′ installed onto the ceiling preferably includes a remote controller for turning on and off the air-cooling illumination apparatus.

In the first and second preferred embodiments, the fan 2 starts rotating, while the bulb of the illumination portion 31 is emitting light, after the air-cooling illumination apparatus 10 is turned on. For example, the switch of turning on/off the fan 2 and the switch of turning on/off the illumination portion 31 can be installed separately.

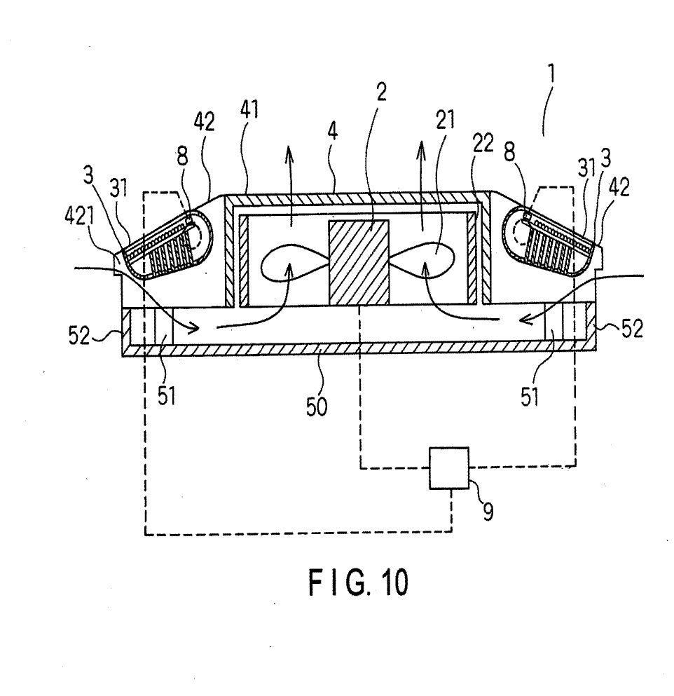

With reference to FIG. 10 for a cross-sectional view of an air-cooling illumination apparatus in accordance with a second preferred embodiment of the present invention, the air-cooling illumination apparatus further comprises a temperature sensor 8 for detecting the temperature of the illumination portion 31 and a control portion 9 for controlling the rotation of the fan 2 according to the temperature detected by the temperature sensor 8. The control portion 9 can be contained within the air-cooling illumination apparatus 1 or installed on an internal side of the plate portion 5. For example, the switches for turning on the fan 2 and the illumination portion 31 are installed separately, and temperature of the illumination portion 31 rises to a specific temperature only if the illumination portion 31 is turned on, and the control portion 9 will control and start rotating the fan 2, such that the fan 2 is controlled by the control portion 9 to rotate compulsorily, so as to reduce the heat produced by the illumination portion 31 and prevent the heat from deteriorating the illumination apparatus. In addition, the temperature detected by the temperature detector can be used for controlling the revolutions per minute (RPM) of the fan 2. For example, the RPM of the fan 2 can be controlled and reduced when the temperature detected by the sensor drops.

If the fan 2 is turned on to rotate compulsorily and the temperature of the illumination portion 31 cannot be lowered within a specific time, it is considered to be having a fire accident, and a warning signal will be issue by an alarm connected to the illumination apparatus.

A WIFI wireless communication module, a ZlGbee wireless communication module or a cable communication module installed inside or outside the air-cooling illumination apparatus 1, 10, 10′ is provided for monitoring the temperature sensor to troubleshoot the air-cooling illumination apparatus or provide a preventive measure. For example, even if the fan 2 is turned on to rotate compulsorily, and the temperature of the illumination portion 31 cannot be lowered within a specific time, but no fire accident occurs, then it is considered to be a failure of the air-cooling illumination apparatus.

In addition, the air-cooling illumination apparatus 1, 10, 10′ having a communication module may further comprises a built-in loudspeaker for providing sound information such as music in office spaces.

If the air-cooling illumination apparatus 1, 10, 10′ and the lamp 3 must be operated manually, a build-in remote control can be installed to achieve the structure of making adjustments.

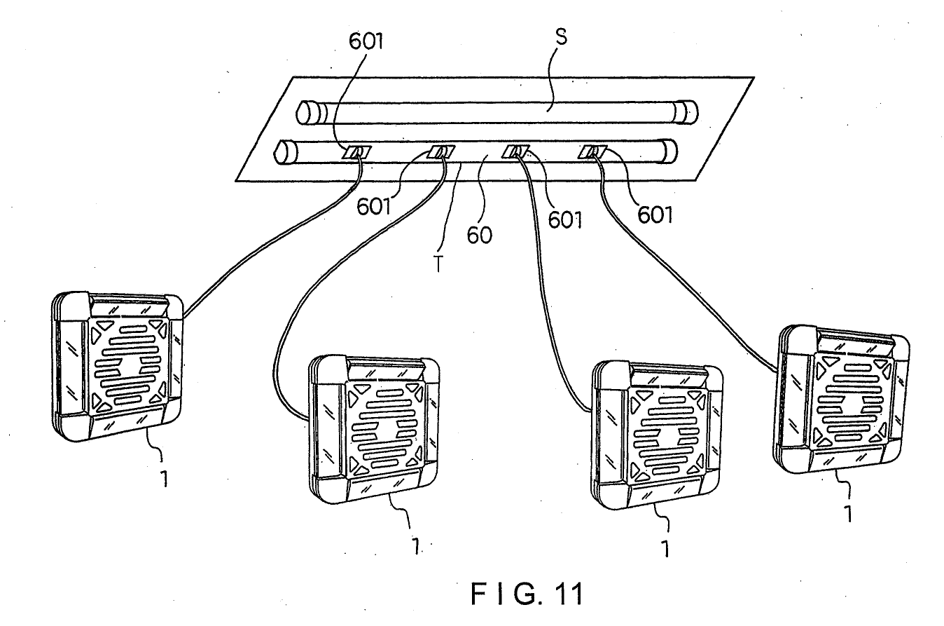

A power plug of the air-cooling illumination apparatus 1, 10 is connected to a nearby electric socket for the supply of electric power, or a power hub 60 with a plurality of sockets is installed at a position of a fluorescent lamp or an LED lamp removed from the ceiling and provided for supplying electric power to the air-cooling illumination apparatus. In FIG. 11, the power hub 60 includes four sockets 601 of a power supply in accordance with the present invention, and each socket 601 is connected to one air-cooling illumination apparatus. The structure of the power hub 60 is in the shape of a plate, and electronic circuits are formed on one of the surfaces of the power hub 60, and a plurality of sockets 601 are disposed on the other surface of the power hub 60. The power hub 60 connected to the connecting portion of the fluorescent lamp or LED lamp S is provided for supplying electric power from the socket 601 to the air-cooling illumination apparatus. Similarly, the electric power is supplied to each air-cooling illumination apparatus installed onto each desk. For example, the input voltage of the power hub 60 is 100 VAC—240 VAC, and the output voltage of the power hub 60 is 12 VDC, 8A, wherein a current of 2A is distributed to each air-cooling illumination apparatus. The power outputted from a power supply can be designed as AC (alternating current), and an adapter is provided for converting the AC into DC (direct current), and the DC is supplied to the air-cooling illumination apparatus 1.

Several sets of air-cooling illumination apparatuses can be installed in an office, and each set comes with a WIFI 802.11a/bgn communication module, and the communication with each air-cooling illumination apparatus is controlled and executed by a server for the central control of the air-cooling illumination apparatuses. For example, the illumination device or the fan of each air-cooling illumination apparatus can be controlled according to weather report and the intensity of sunlight projected through windows of a building. In other words, the quantity of emitted light of the LED is reduced for the air-cooling illumination apparatus placed next to a window in a sunny day, since the hot weather will speed up the rotation speed of the fan of an air-cooling illumination apparatus placed at a position farther from the air-conditioner, and thus an appropriate control can achieve the power saving effect. To obtain the ambient data, each air-cooling illumination apparatus further comprises a temperature sensor, a humidity sensor, a pressure sensor and a light intensity sensor, and learns the energy consumption for the illumination and air-cooling effect with respect to the change of environmental conditions in a season or a day, and an appropriate control is applied to each air-cooling illumination apparatus to achieve the effect of saving power for the whole office.

Even in an environment installed with an air-conditioner, the air-cooling device can be installed and adjusted separately, and the air cooling device can be adjusted according to the temperature set by the existing air-conditioner, so as to achieve the power saving effect.

The plate portion 5 of the aforementioned preferred embodiments includes the flange 52, or it comes with no flange 52.

The lamp 3 of the aforementioned preferred embodiments includes the cooling fin portion 32, or the lamp 3 can have no cooling fin portion 32 if the cooling effect meets the user requirement.

The fan mount portions 41, 41′ of the connecting portion 4 of the aforementioned preferred embodiments come with a front side 411, 411′ of any shape as long as it can install the fan 2, or do not come with a front side.

The front side of the air-cooling illumination apparatus 1, 10, 10′ of the aforementioned preferred embodiments can be in a rectangular shape. The shape is not limited to rectangular only, but it can be a polygonal or circular shape as well. The shape of the front side of the fan 2, the frame 22 and the fan mount portion 41 is not limited to rectangular, but it can be a polygonal or circular shape.

The lamp 3 of the aforementioned preferred embodiments can be in a square shape or a thick-plate shape, but it can be in a curved shape, too. The lamp 3 may be designed as a non-rotatable structure.

In summation, the air-cooling illumination apparatus of the present invention is capable of reducing the heat generated by the illumination apparatus to prevent the illumination apparatus from being deteriorated by the heat, and the air-cooling illumination apparatus can be used in office or at home.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An air-cooling illumination apparatus, comprising a fan, a lamp installed on an air passage movable by a rotation of the fan, and a connecting portion for coupling the lamp and the fan.

2. The air-cooling illumination apparatus of claim 1, wherein the fan further comprises a plate portion disposed at an air suction end of the fan and arranged with a first interval from the fan, a rotatable vane portion, and a frame mounted around the vane portion, and the lamp comprises a illumination portion installed around the periphery of the frame and provided for projecting a light to an air blowing end of the fan, and a second interval is formed between the lamp and the plate portion.

3. The air-cooling illumination apparatus of claim 2, wherein the connecting portion further comprises a fan mount portion for mounting the fan, and a lamp support portion disposed around the periphery of the fan mount portion for supporting the lamp, and the plate portion is fixed to the connecting portion.

4. The air-cooling illumination apparatus of claim 3, wherein the lamp is in a thick-plate shape, and rotatably supported along a long-side direction of the lamp by the lamp support portion.

5. The air-cooling illumination apparatus of claim 4, wherein the fan mount portion is in a rectangular shape, and the lamp support portion is formed separately at four corners of the rectangular shape, and four sides of the rectangular shape are parallely disposed with an interval apart in long-side direction of the lamp.

6. The air-cooling illumination apparatus of claim 2, wherein the lamp is installed at an opposite end of the illumination portion and comprises a cooling fin portion for the cooling illumination portion, and the second interval is formed between the cooling fin portion and the plate portion, and the fan sucks air through the second interval and the first interval.

7. The air-cooling illumination apparatus of claim 2, further comprising a temperature sensor for detecting a temperature of the illumination portion, and a control portion for controlling the fan according to the temperature detected by the temperature sensor.

8. The air-cooling illumination apparatus of claims 1, wherein the connecting portion connected to a fluorescent lamp or an LED (Light emitting Diode) lamp comprises a power hub with a plurality of power supply devices for supplying electric power.

9. The air-cooling illumination apparatus of claims 2, wherein the connecting portion connected to a fluorescent lamp or an LED lamp comprises a power hub with a plurality of power supply devices for supplying electric power.

10. The air-cooling illumination apparatus of claims 3, wherein the connecting portion connected to a fluorescent lamp or an LED lamp comprises a power hub with a plurality of power supply devices for supplying electric power.

11. The air-cooling illumination apparatus of claims 4, wherein the connecting portion connected to a fluorescent lamp or an LED lamp comprises a power hub with a plurality of power supply devices for supplying electric power.

12. The air-cooling illumination apparatus of claims 5, wherein the connecting portion connected to a fluorescent lamp or an LED lamp comprises a power hub with a plurality of power supply devices for supplying electric power.

13. The air-cooling illumination apparatus of claims 6, wherein the connecting portion connected to a fluorescent lamp or an LED lamp comprises a power hub with a plurality of power supply devices for supplying electric power.

14. The air-cooling illumination apparatus of claims 7, wherein the connecting portion connected to a fluorescent lamp or an LED lamp comprises a power hub with a plurality of power supply devices for supplying electric power.
